(19) United States
(12) Patent Application Publication
(10) Pub. No.: US 2021/0326657 A1
(43) Pub. Date: Oct. 21, 2021

(54) IMAGE RECOGNITION METHOD AND DEVICE THEREOF AND AI MODEL TRAINING METHOD AND DEVICE THEREOF

(71) Applicant: PEGATRON CORPORATION, TAIPEI CITY (TW)

(72) Inventor: Po-Sen Chen, Taipei City (TW)

(73) Assignee: PEGATRON CORPORATION, TAIPEI CITY (TW)

(21) Appl. No.: 17/200,345

(22) Filed: Mar. 12, 2021

(30) Foreign Application Priority Data
Apr. 21, 2020 (TW) 109113254

(51) Int. Cl. G06K 9/62; G06K 9/00; G06K 9/46; G06T 7/246

(52) U.S. Cl. CPC G06K 9/6262; G06K 9/00355; G06T 7/251; G06K 9/6256; G06K 9/4652

(57) ABSTRACT

An image recognition method and a device thereof and an AI model training method and a device thereof are provided. The image recognition method includes: retrieving an input image with an image sensor; detecting an object in the input image and a plurality of characteristic points corresponding to the object, and obtaining real-time 2D coordinate information of the characteristic points; determining a distance between the object and the image sensor according to the real-time 2D coordinate information of the characteristic points through an AI model; and performing a motion recognition operation on the object based on that the distance is less than or equal to a threshold.

### CROSS-REFERENCE TO RELATED APPLICATION

This application claims the priority benefit of Taiwan application serial no. 109113254, filed on Apr. 21, 2020. The entirety of the above-mentioned patent application is hereby incorporated by reference herein and made a part of this specification.

### BACKGROUND

### Technical Field

The disclosure relates to an image recognition method and a device thereof, and an AI (artificial intelligence) model training method and a device thereof, more particularly, to an image recognition method and an electronic device that reduce an error rate of motion recognition at low cost.

### Description of Related Art

In the field of motion recognition, if there is interference from other people in the background environment, it may cause a misjudgment of motions for a specific user. Take gesture recognition as an example, the system may erroneously recognize the gestures of other people in the background and cause incorrect operations when a user uses gestures to manipulate the slides in front of a computer. In the existing methods, it is possible to lock a specific user through face recognition or a closer user through a depth image sensor, but these methods will increase recognition time and hardware costs so that they cannot be implemented in electronic devices with limited hardware resources. Therefore, how to reduce the error rate of motion recognition at a low cost is a goal for those skilled in the art.

### SUMMARY

The disclosure provides an image recognition method and a device thereof, and an AI model training method and a device thereof, which reduce an error rate of motion recognition at low cost.

The disclosure provides an image recognition method including: retrieving an input image with an image sensor; detecting an object in the input image and a plurality of characteristic points corresponding to the object, and obtaining real-time 2D coordinate information of the characteristic points; determining a distance between the object and the image sensor according to the real-time 2D coordinate information of the characteristic points through an AI model; and performing a motion recognition operation on the object based on that the distance is less than or equal to a threshold.

The disclosure provides an AI model training method adapted for training an AI model so that the AI model determines a distance between an object in an input image and an image sensor in an inference phase. The AI model training method includes: retrieving a training image with a depth image sensor; detecting a training object in the training image and a plurality of training characteristic points corresponding to the training object, and obtaining 2D coordinate information and 3D coordinate information of the characteristic points of the training object; and training the AI model to determine a distance between the object in the input image and the image sensor according to real-time 2D coordinate information of a plurality of characteristic points of the object in the input image with the 2D coordinate information and the 3D coordinate information of the training object as input information.

The disclosure provides an image recognition device including: an image sensor retrieving an input image; a detection module detecting an object in the input image and a plurality of characteristic points corresponding to the object, and obtaining real-time 2D coordinate information of the characteristic points; an AI model determining a distance between the object and the image sensor according to the real-time 2D coordinate information of the characteristic points; and a motion recognition module performing a motion recognition operation on the object based on that the distance is less than or equal to a threshold.

The disclosure provides an AI model training device adapted for training an AI model so that the AI model determines a distance between an object in an input image and an image sensor in an inference phase. The AI model training device includes: a depth image sensor retrieving a training image; a detection module detecting a training object in the training image and a plurality of training characteristic points corresponding to the training object, and obtaining 2D coordinate information and 3D coordinate information of the training characteristic points of the training object; and a training module training the AI model to determine the distance between the object in the input image and the image sensor according to real-time 2D coordinate information of a plurality of characteristic points of the object in the input image with the 2D coordinate information and the 3D coordinate information of the training object as input information.

Based on the above, the image recognition method and the device thereof and the AI model training method and the device thereof provided in the disclosure first obtain the 2D coordinate information and the 3D coordinate information of the characteristic points of the training object in the training image with the depth image sensor in the training phase, and the AI model is trained with the 2D coordinate information and the 3D coordinate information. Therefore, in the actual image recognition, an image sensor without a depth information function is sufficient to obtain the real-time 2D coordinate information of the characteristic points of the object in the input image, making it possible to determine the distance between the object and the image sensor according to the real-time 2D coordinate information. In this way, the image recognition method and the electronic device of the disclosure reduce the error rate of motion recognition at lower hardware costs.

### BRIEF DESCRIPTION OF THE DRAWINGS

FIG. 1 is a block diagram of an electronic device used in an inference phase of image recognition according to an embodiment of the disclosure.

FIG. 2 is a block diagram of an electronic device used in a training phase of image recognition according to an embodiment of the disclosure.

FIG. 3 is a flowchart of a training phase of image recognition according to an embodiment of the disclosure.

FIG. 4 is a flowchart of an inference phase of image recognition according to an embodiment of the disclosure.

### DETAILED DESCRIPTION OF DISCLOSED EMBODIMENTS

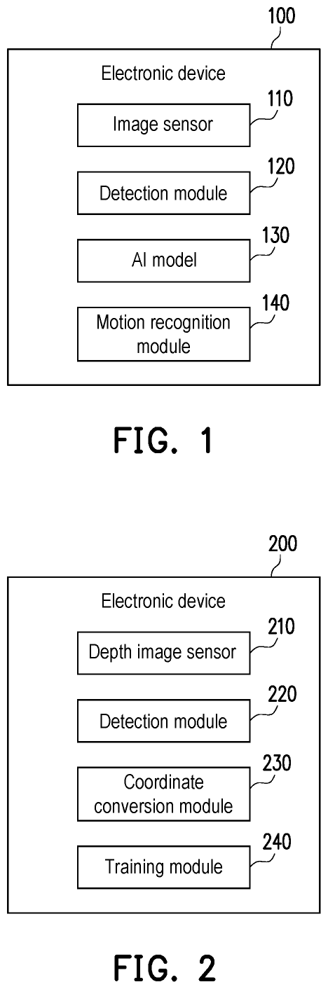

FIG. 1 is a block diagram of an electronic device used in an inference phase of image recognition according to an embodiment of the disclosure.

Referring to FIG. 1, an electronic device 100 (or called an AI model training device) according to an embodiment of the disclosure includes an image sensor 110, a detection module 120, an AI model 130, and a motion recognition module 140. The electronic device 100 includes, for example, a personal computer, a tablet computer, a notebook computer, a smart phone, an in-vehicle device, a household device, etc., and is used for real-time motion recognition. The image sensor 110 includes, for example, a color camera (such as an RGB camera) or other similar elements. In an embodiment, the image sensor 110 does not have a depth information sensing function. The detection module 120, the AI model 130, and the motion recognition module 140 may be implemented by one or any combination of software, firmware, and hardware circuits, and the disclosure is not intended to limit how the detection module 120, the AI model 130, and the motion recognition module 140 are implemented.

In an inference phase, that is, in an actual image recognition phase, the image sensor 110 retrieves an input image. The detection module 120 detects an object in the input image and a plurality of characteristic points corresponding to the object, and obtains real-time 2D coordinate information of the characteristic points. The object includes, for example, body parts such as hands, feet, human bodies, and faces, etc., and the characteristic points include, for example, joint points of the hands, feet, or human bodies and the characteristic points of the faces, etc. The joint points of the hands are located on, for example, fingertips, palms, and roots of fingers of the hands. The 2D coordinate information of the characteristic points is input into the AI model 130 that is trained in advance. The AI model 130 determines a distance between the object and the image sensor 110 according to the real-time 2D coordinate information of the characteristic points. Based on that the distance between the object and the image sensor 110 is less than or equal to a threshold (for example, 50 cm), the motion recognition module 140 performs a motion recognition operation (for example, a gesture recognition operation, etc.) on the object. Based on that the distance between the object and the image sensor 110 is greater than the threshold, the motion recognition module 140 does not perform the motion recognition operation on the object. In this way, when other objects in the background are also in motion, the motions of the background objects are ignored and the error rate of motion recognition is reduced.

Note that the AI model 130 includes, for example, a deep learning model such as convolutional neural network (CNN) or recurrent neural network (RNN), etc. The AI model 130 is trained with the 2D coordinate information and the 3D coordinate information of the characteristic points (or called training characteristic points) of the training objects in a plurality of training images as input information, which enables the AI model 130 to determine the distance between the object and the image sensor 110 only by the real-time 2D coordinate information of the object in the actual image recognition phase. A training of the AI model 130 is described in detail below.

FIG. 2 is a block diagram of an electronic device used in a training phase of image recognition according to an embodiment of the disclosure.

Referring to FIG. 2, an electronic device 200 (or called an image recognition device) according to an embodiment of the disclosure includes a depth image sensor 210, a detection module 220, a coordinate conversion module 230, and a training module 240. The electronic device 200 includes, for example, a personal computer, a tablet computer, a notebook computer, a smart phone, etc., and is used for training an AI model. The depth image sensor 210 includes, for example, a depth camera or other similar elements. The detection module 220, the coordinate conversion module 230, and the training module 240 may be implemented by one or any combination of software, firmware, and hardware circuits, and the disclosure is not intended to limit how the detection module 220, the coordinate conversion module 230, and the training module 240 are implemented.

In a training phase, the depth image sensor 210 retrieves a training image. The detection module 220 detects a training object in the training image and a plurality of characteristic points corresponding to the training object, and obtains 2D coordinate information of the characteristic points of the training object. The coordinate conversion module 230 converts the 2D coordinate information into 3D coordinate information through a projection matrix. The training module 240 trains the AI model according to the 2D coordinate information and the 3D coordinate information. In the inference phase, the AI model detects the object in the input image and determines the distance between the object and the image sensor according to the real-time 2D coordinate information of the characteristic points of the object. In another embodiment, the depth image sensor 210 also retrieves the training image and directly obtains the 2D coordinate information and the 3D coordinate information of the characteristic points of the training object in the training image, and the training module 240 trains the AI model with the 2D coordinate information and the 3D coordinate information as input training information.

For example, in the training phase, a data set including a plurality of training images is created. The data set may include a large number of RGB images and annotations. The annotation marks a position of the object in each of the RGB images and the 3D coordinate information of the characteristic points of the object. The 3D coordinate information of the characteristic points of the object is obtained by the depth image sensor 210 described above. The training module 240 calculates an average distance between the characteristic points of the training object and the depth image sensor 210 according to the 3D coordinate information of the characteristic points of the training object to obtain a distance between the training object and the depth image sensor 210.

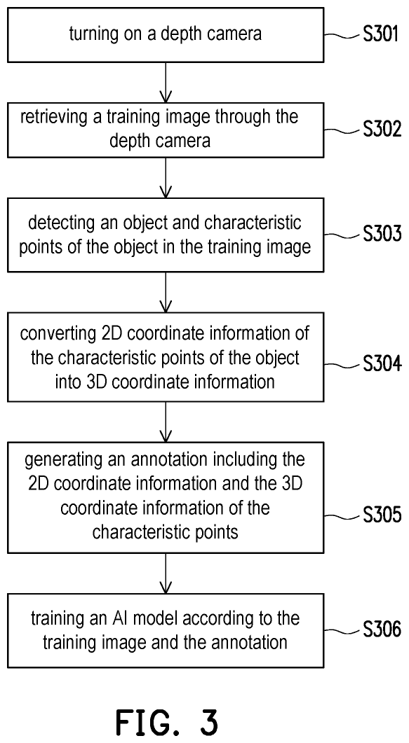

FIG. 3 is a flowchart of a training phase of image recognition according to an embodiment of the invention.

Referring to FIG. 3, in step S301, a depth camera is turned on.

In step S302, a training image is retrieved through the depth camera.

In step S303, an object and characteristic points of the object in the training image are detected.

In step S304, 2D coordinate information of the characteristic points of the object is converted into 3D coordinate information.

In step S305, an annotation including the 2D coordinate information and the 3D coordinate information of the characteristic points is generated. Note that the annotation may only include the 2D coordinate information of the characteristic points and the distance from the object to the depth camera, where the distance from the object to the depth camera may be the average distance from all the characteristic points of the object to the depth camera.

In step S306, the AI model is trained according to the training image and the annotation.

Note that in the training phase of image recognition, supervised learning may be used to input a coordinate data set of the object (for example, the 2D coordinate information and the 3D coordinate information of the object, or the 2D coordinate information of the object and the distance from the object to the depth camera), whereby the AI model is trained to analyze the distance from the object to the depth camera according to the 2D coordinate information of the characteristic points of the object.

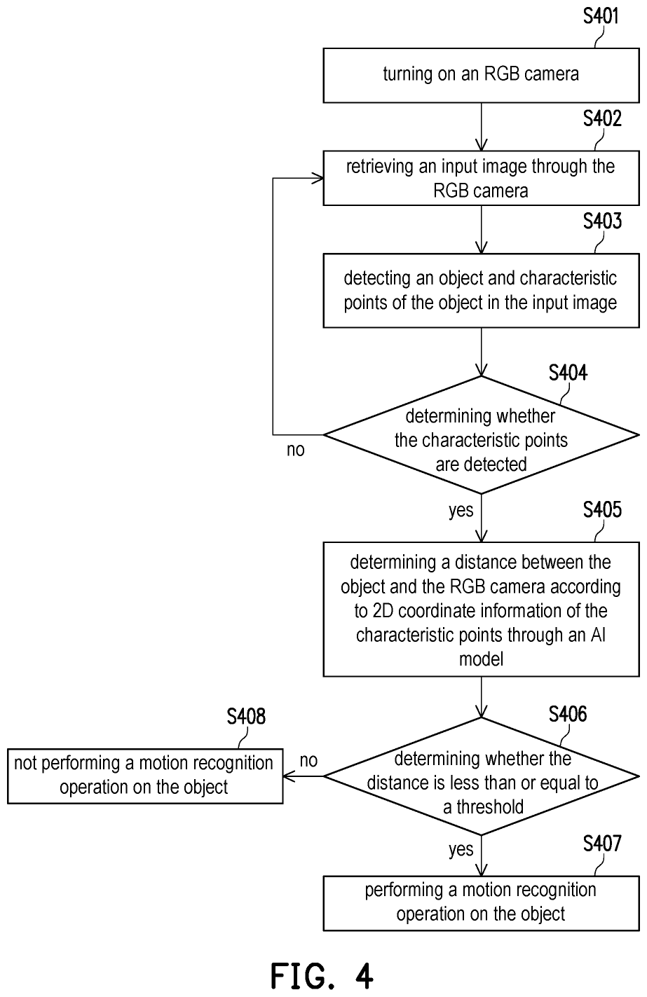

FIG. 4 is a flowchart of an inference phase of image recognition according to an embodiment of the disclosure.

Referring to FIG. 4, in step S401, an RGB camera is turned on.

In step S402, an input image is retrieved through the RGB camera.

In step S403, an object and characteristic points of the object in the input image are detected.

In step S404, it is determined whether the characteristic points are detected.

If the characteristic points are not detected, the process returns to step S402 to retrieve the input image through the RGB camera again. If the characteristic points are detected, in step S405, a distance between the object and the RGB camera is determined according to 2D coordinate information of the characteristic points through an AI model.

In step S406, it is determined whether the distance is less than or equal to a threshold.

If the distance is less than or equal to the threshold, in step S407, a motion recognition operation is performed on the object.

If the distance is greater than the threshold, in step S408, the motion recognition operation is not performed on the object.

In summary, the image recognition method and the electronic device of the disclosure first obtain the 2D coordinate information and the 3D coordinate information of the characteristic points of the training object in the training image with the depth image sensor in the training phase, and the AI model is trained with the 2D coordinate information and the 3D coordinate information. Therefore, in the inference phase, an image sensor without a depth information function is sufficient to obtain the real-time 2D coordinate information of the characteristic points of the object in the input image, making it possible to determine the distance between the object and the image sensor according to the real-time 2D coordinate information. In this way, the image recognition method and the electronic device of the disclosure reduce the error rate of motion recognition at lower hardware costs.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. An image recognition method, comprising:
retrieving an input image with an image sensor;
detecting an object in the input image and a plurality of characteristic points corresponding to the object, and obtaining real-time 2D coordinate information of the characteristic points;
determining a distance between the object and the image sensor according to the real-time 2D coordinate information of the characteristic points through an AI model; and
performing a motion recognition operation on the object based on that the distance is less than or equal to a threshold.

2. The image recognition method according to claim 1, further comprising: training the AI model with 2D coordinate information and 3D coordinate information of a plurality of training characteristic points of a training object in a plurality of training images as input information.

3. The image recognition method according to claim 1, further comprising: not performing the motion recognition operation on the object based on that the distance is greater than the threshold.

4. The image recognition method according to claim 1, wherein the object comprises a hand, and the characteristic points are a plurality of joint points of the hand, and the joint points correspond to at least one or a combination of fingertips, palms, and roots of fingers of the hand.

5. The image recognition method according to claim 1, wherein the image sensor is a color camera.

6. An AI model training method adapted for training an AI model so that the AI model determines a distance between an object in an input image and an image sensor in an inference phase, the AI model training method comprising:
retrieving a training image with a depth image sensor;
detecting a training object in the training image and a plurality of training characteristic points corresponding to the training object, and obtaining 2D coordinate information and 3D coordinate information of the training characteristic points of the training object; and
training the AI model to determine the distance between the object in the input image and the image sensor according to real-time 2D coordinate information of a plurality of characteristic points of the object in the input image with the 2D coordinate information and the 3D coordinate information of the training object as input information.

7. The AI model training method according to claim 6, further comprising: calculating an average distance between the training characteristic points of the training object and the depth image sensor according to the 3D coordinate information of the training characteristic points of the training object to obtain a distance between the training object and the depth image sensor.

8. The AI model training method according to claim 6, wherein a projection matrix of the depth image sensor converts the 2D coordinate information of the training characteristic points of the object into the 3D coordinate information.

9. The AI model training method according to claim 6, further comprising: generating an annotation comprising the 2D coordinate information and the 3D coordinate information of the training characteristic points, and training the AI model according to the annotation and the training image.

10. The AI model training method according to claim 6, further comprising: generating an annotation comprising the 2D coordinate information of the training characteristic points and a distance from the object to the depth image sensor, and training the AI model according to the annotation and the training image.

11. An image recognition device, comprising:
an image sensor retrieving an input image;
a detection module detecting an object in the input image and a plurality of characteristic points corresponding to the object, and obtaining real-time 2D coordinate information of the characteristic points;
an AI model determining a distance between the object and the image sensor according to the real-time 2D coordinate information of the characteristic points; and
a motion recognition module performing a motion recognition operation on the object based on that the distance is less than or equal to a threshold.

12. The image recognition device according to claim 11, wherein the AI model is trained with 2D coordinate information and 3D coordinate information of a plurality of training characteristic points of a training object in a plurality of training images as input information.

13. The image recognition device according to claim 11, wherein the motion recognition module does not perform the motion recognition operation on the object based on that the distance is not less than the threshold.

14. The image recognition device according to claim 11, wherein the object comprises a hand, and the characteristic points are a plurality of joint points of the hand, and the joint points correspond to at least one or a combination of fingertips, palms, and roots of fingers of the hand.

15. The image recognition device according to claim 11, wherein the image sensor is a color camera.

16. An AI model training device adapted for training an AI model so that the AI model determines a distance between an object in an input image and an image sensor in an inference phase, and the AI model training device comprising:
a depth image sensor retrieving a training image;
a detection module detecting a training object in the training image and a plurality of training characteristic points corresponding to the training object, and obtaining 2D coordinate information and 3D coordinate information of the training characteristic points of the training object; and
a training module training the AI model to determine the distance between the object in the input image and the image sensor according to real-time 2D coordinate information of a plurality of characteristic points of the object in the input image with the 2D coordinate information and the 3D coordinate information of the training object as input information.

17. The AI model training device according to claim 16, wherein the training module calculates an average distance between the training characteristic points of the training object and the depth image sensor according to the 3D coordinate information of the training characteristic points of the training object to obtain a distance between the training object and the depth image sensor.

18. The AI model training device according to claim 16, wherein a projection matrix of the depth image sensor converts the 2D coordinate information of the training characteristic points of the training object into the 3D coordinate information.

19. The AI model training device according to claim 16, wherein the training module generates an annotation comprising the 2D coordinate information and the 3D coordinate information of the training characteristic points, and trains the AI model according to the annotation and the training image.

20. The AI model training device according to claim 16, wherein the training module generates an annotation comprising the 2D coordinate information of the training characteristic points and a distance from the object to the depth image sensor, and trains the AI model according to the annotation and the training image.
